(19) United States
(12) Patent Application Publication
(10) Pub. No.: US 2012/0269680 A1
(43) Pub. Date: Oct. 25, 2012

(54) Transportation Mechanism For Laterally And Intermittently Transporting A Test Tube Rack And Medical Analyzer Utilizing The Mechanism

(75) Inventors: Sheng CAO, Shenzhen (CN); Lechang LI, Shenzhen (CN)

(73) Assignee: SHENZHEN MINDRAY BIO-MEDICAL ELECTRONICS CO., LTD., Shenzhen (CN)

(21) Appl. No.: 13/448,486

(22) Filed: Apr. 17, 2012

(30) Foreign Application Priority Data
Apr. 19, 2011 (CN) 201110098173.8

(51) Int. Cl. G01N 35/04

(52) U.S. Cl. 422/65

(57) ABSTRACT

A transportation mechanism for transporting a test tube rack laterally and intermittently is disclosed. The transportation mechanism includes a test tube rack, one or more fingers and a driving mechanism that drives the finger to move. The finger has a loading state and an unloading state in its movement process. In the loading state, the finger extends upward and into the test tube rack and causes the rack to move laterally. In the unloading state, the finger retrieves downward and out of the test tube rack. Because the finger is driven by the driving mechanism, there is no need to use a restriction metal sheet to press down the finger. As a result, there is no mechanical collision between the finger and the restriction metal sheet, and noise is effectively reduced in the operation.

### CROSS-REFERENCE TO RELATED APPLICATIONS

This application claims the benefit of Chinese Patent Application No. 201110098173.8, filed Apr. 19, 2011, which is incorporated herein by reference in its entirety.

### TECHNICAL FIELD

The following disclosure relates to a transportation mechanism for laterally and intermittently transporting a test tube rack and a medical analyzer utilizing the transportation mechanism.

### BACKGROUND OF THE INVENTION

An existing transportation mechanism for laterally and intermittently transporting a test tube rack commonly uses a repositioning pawl structure base upon gravitation or spring. This type of mechanism generally includes a test tube rack 1, a linear guide track 2, a movable supporter 3, a fixed supporter 4, a rotating bearing 5, pawls 6 and a test tube rack holding plate that further functions as a restriction metal sheet 601 of the existing transportation mechanism. The operating process of the mechanism is shown as follows:

A) as shown in FIGS. 1a and 1a₁, two pawls 6 are at an initial position, wherein the pawls are pressed by the restriction metal sheet 601;

B) as shown in FIGS. 1b and 1b₁, when the two pawls 6 are moved to the right following the movement of the movable supporter 3, the pawls 6 are rotated under gravity, and the top of the pawls 6 extends through the open slots 602 in the restriction metal sheet 601 into the groove 11 at the bottom of the test tube rack, so as to push the test tube rack move to the right by one groove width.

C) as shown in FIGS. 1c and 1c₁, when the pawls are moved to the left following the movement of the movable supporter 3, the top of pawls is pressed by the left edge of the open slots 602 of the restriction metal sheet 601, exiting from the open slots 602 and the pawls are rotated back to the initial position. In further repeating cycles, the test tube rack 1 is moved to the right intermittently in the same manner.

The mechanism has two disadvantages. A) The system is noisy. As discussed above in reference to FIGS. 1c and 1c₁, when the pawls 6 are moved back to the left with the movable support 3, the top of the pawls 6 is pressed by the restriction metal sheet 601. As such, the top of the pawls 6 knocks repetitively on the restriction metal sheet 601 when the pawls are moved following the movement of the movable supporter 3, which generates noises. B) The rotating bearing tends to rust due to liquid spill and tends to malfunction, and the rotating bearing may be stuck, which renders the pawls not possible to reset.

### SUMMARY OF THE INVENTION

Disclosed herein are embodiments of a transportation mechanism for laterally and intermittently transporting a test tube rack, and a medical analyzer having the transportation mechanism.

### BRIEF DESCRIPTION OF THE DRAWINGS

FIGS. 1a-1c are schematic diagrams of an existing transportation mechanism for laterally and intermittently transporting a test tube rack; and FIGS. 1a₁-1c₁ are schematic top views of the existing transportation mechanism shown in FIGS. 1a-1c, respectively, with the test tube rack removed. The schematic illustration in FIGS. 1a-1c is taken along a plane across both open slots 602 in FIGS. 1a₁-1c₁.

FIGS. 2a-2e are schematic diagrams of the first embodiment of the present disclosure; and FIGS. 2a₁-2e₁ are schematic top views of the transportation mechanism shown in FIGS. 2a-2e, respectively, with the test tube rack removed. The schematic illustration in FIGS. 2a-2e is taken along a plane across openings 42 and 42′ in FIGS. 2a₁-2e₁.

FIGS. 3a-3b are schematic diagrams of the second embodiment of the present disclosure.

FIGS. 4a-4b are schematic diagrams of the third embodiment of the present disclosure.

FIGS. 5a-5b are schematic diagrams of the forth embodiment of the present disclosure.

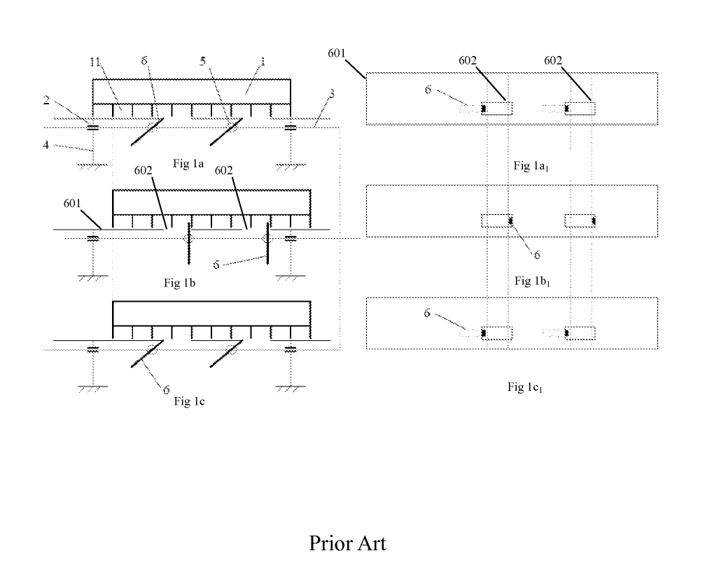

### DETAILED DESCRIPTION

This disclosure provides a transportation mechanism for laterally and intermittently transporting a test tube rack, which reduces noise, and a medical analyzer having the transportation mechanism. The mechanism comprises a test tube rack, at least one finger and a driving mechanism that drives the finger. The finger has a loading state and an unloading state in its movements. In the loading state, the finger extends upward and into the test tube rack and drives the test tube rack to move laterally. In the unloading state, the finger retrieves downward and out of the test tube rack.

In one embodiment, the transportation mechanism comprises a movable supporter and a linear guide track which are slideably fit, the driving mechanism is a linear motion executive element for driving the fingers to move linearly, or a rotary motion executive element for driving the fingers to rotate. The driving mechanism is set on the movable supporter.

In one embodiment, the driving mechanism is a linear motion executive element, which drives the finger to move up and down.

In one embodiment, the finger includes a connecting shaft and a toggling shaft which are affixed together. The connecting shaft is connected with a movable part of the driving mechanism. The toggling shaft is vertical.

In one embodiment, the movable part of the driving mechanism drives the connecting shaft to move up and down vertically or slantingly.

In one embodiment, the driving mechanism is a rotary motion executive element, and the finger is pivotally connected with the movable supporter.

In one embodiment, the linear motion executive element can be a gas cylinder, a linear electric motor or an electromagnet. The rotary motion executive element can be a revolving cylinder or an electromagnet.

This disclosure also provides a medical analyzer, which includes the present transportation mechanism for laterally and intermittently transporting a test tube rack.

The present transportation mechanism utilizes a driving mechanism to drive the finger, and does not use the test tube rack holding plate to press the finger. As a result, in the repetitive moving cycles, there is no mechanical collision between the finger and the test tube rack holding plate, and noise during operation of the medical analyzer is reduced effectively.

The present disclosure will be illustrated in detail by the following embodiments and figures.

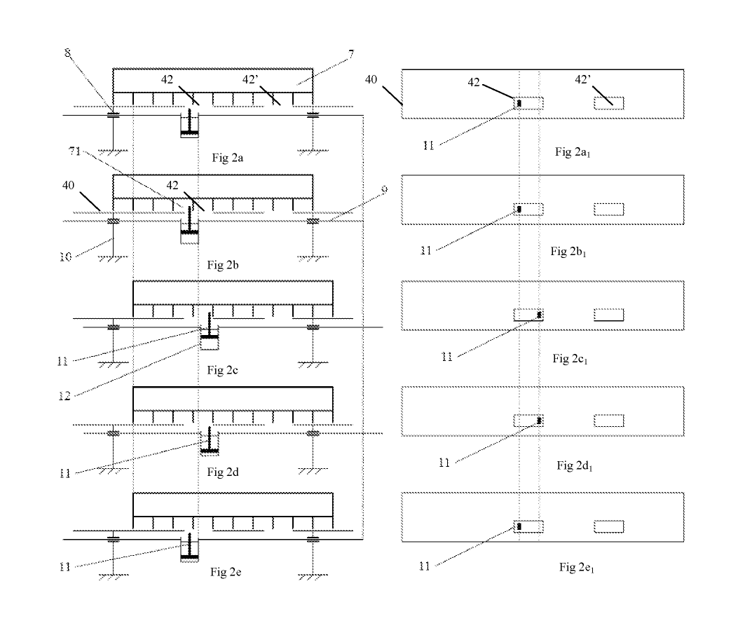

The first embodiment of the transportation mechanism for laterally and intermittently transporting a test tube rack is shown in FIGS. 2a-2e and 2a₁-2e₁. The transportation mechanism includes a test tube rack 7, a linear guide track 8, a movable supporter 9, a fixed supporter 10, a finger 11 and a gas cylinder 12. The test tube rack 7 is disposed on top of a test tube rack holding plate 40, above an opening 42 or 42′ of the holding plate. The bottom of the test tube rack 7 has grooves 71 in a row. The test tube rack holding plate 40 has two openings 42 and 42′ in the direction of the movable supporter 9. The linear guide track 8 is under the test tube rack 7 and the test tube rack holding plate 40, and the movable supporter 9 is slideably disposed on the linear guide track 8. The linear guide track 8 is affixed with the fixed supporter 10. The finger 11 may be a L-shape structure which is made by a molding process, and finger 11 is connected directly to the gas cylinder 12. The gas cylinder 12 is installed on the movable supporter 9, and can be moved laterally along with the movable supporter 9 on the linear guide track 8.

The operating process of the transportation mechanism is as follows:

As shown in FIG. 2a, after initialization of the mechanism, the finger 11 is at a lower position (i.e. the entire finger is underneath the test tube rack), and is moved along with the movable supporter 9 to the leftmost initial position.

As shown in FIG. 2b, when the test tube rack 7 needs to be moved laterally, the gas cylinder 12 drives the finger 11 to extend upward vertically and the finger is moved to an upper position through the opening 42 and into a groove 71 located in the bottom of the test tube rack. Also see FIGS. 2a₁ and 2b₁.

As shown in FIGS. 2c and 2c₁, the movable supporter 9 drives the gas cylinder 12 and the finger 11 to move to the right by one groove width. At the same time, the finger 11 drives the test tube rack 7 to move to the right.

As shown in FIGS. 2d and 2d₁, when the test tube rack 7 is moved to a designated position, the finger 11 is retrieved to the lower position and separated from the test tube rack (i.e. the finger is retrieved downward and completely out of the groove of the test tube rack).

As shown in FIGS. 2e and 2e₁, the movable supporter 9 is moved to the left, back to the initial position, which drives the finger 11 and gas cylinder 12 back to the initial position. In other words, the finger 11 is reset laterally. At this time, one movement cycle of the test tube rack is finished. In the same manner, the test tube rack can feed a test tube to an analyzer intermittently over and over again.

Moreover, when the test tube rack 7 is moved several times toward the right and the left end of the test tube rack reaches the opening 42, the movable supporter 9 can then drive the gas cylinder 12 and the finger 11 to the right along the test tube rack holding plate 40, and position the gas cylinder 12 and the finger 11 under the opening 42′. The same operating process described above is then continued at this location until the left end of the test tube rack 7 passes the opening 42′. At this time, all test tubes in the test tube rack have been fed to the analyzer. In the embodiment illustrated in FIGS. 2a-2e and 2a₁-2e₁, the openings 42 and 42′ are in the form of two separate rectangular openings. However, it should be understood that other suitable configurations and shapes can also be used for the purpose of the invention. For example, one continuous elongated opening along the test tube rack holding plate can be provided.

In this embodiment, the finger moves back and forth intermittently between the lower position and the upper position in the vertical direction. When it is in the upper position, the finger is in a loading state and can drive the test tube rack to move to the right. When it is in the lower position, the finger is retrieved downward out of the test tube rack.

In this embodiment, the finger is driven directly by the gas cylinder to move up and down through the opening of the test tube rack holding plate. In such movements, the finger does not knock on, or in contact with, the test tube rack holding plate to generate noise. As can be appreciated, different from the prior art device, the present transportation mechanism does not rely on the test tube rack holding plate to press or restrict the finger. In addition, a sheet metal protection cover may be used to protect the gas cylinder and finger. Therefore, the present transportation mechanism does not have the problem of corrosion of the rotating bearing of the existing technology, and has an improved reliability.

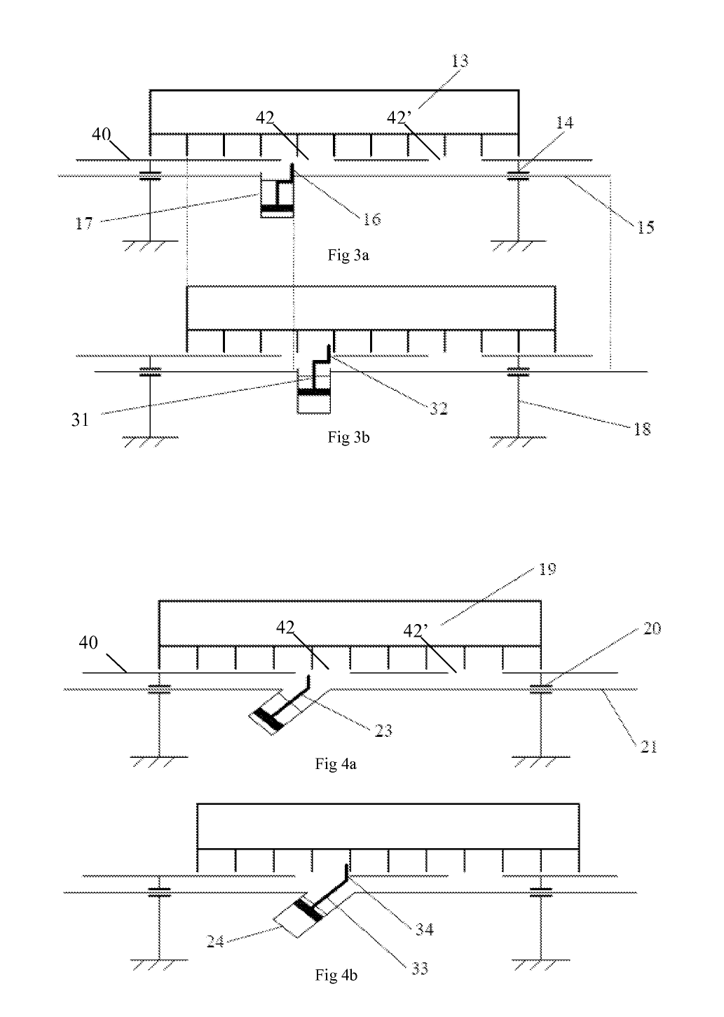

The second embodiment is shown in FIGS. 3a and 3b. The difference of the second embodiment to the first embodiment is that the finger 16 has an eccentric structure. The finger 16 has a connecting shaft 31 and toggling shaft 32 which are parallel with each other and eccentric. The connecting shaft 31 is connected to the gas cylinder 17 directly. The toggling shaft 32 is oriented vertically and can drive the test tube rack 13 to move to the right. The gas cylinder 17 is installed on the movable supporter 15. The movable supporter 15 and the linear guide track 14 are slideably fit. The linear guide track 14 is affixed to the fixed supporter 18.

As shown in FIG. 3a, at the initial position, the finger 16 is at a lower position. As shown in FIG. 3b, when the test tube rack 13 needs to be moved laterally to feed a test tube to an analyzer, the gas cylinder 17 drives the finger to move upward vertically and the toggling shaft 32 extends upward through the opening 42 and into a groove of the test tube rack.

The third embodiment is shown in FIGS. 4a and 4b. The difference of the third embodiment to the second embodiment is that a gas cylinder 24 is installed inclined and the toggling shaft 34 of a finger 23 is oriented vertically and the connecting shaft 33 is inclined. As shown in FIG. 4a, at the initial position, the finger 23 is at a lower position. As shown in FIG. 4b, when the test tube rack 19 needs to be moved laterally to feed a test tube to an analyzer, the gas cylinder 24 drives the finger 23 to rise and the toggling shaft 34 extends vertically upward and into a groove of the test tube rack. The movable supporter 21 is moved to the right along the linear guide track 20 and the test tube rack 19 is driven to move to the right.

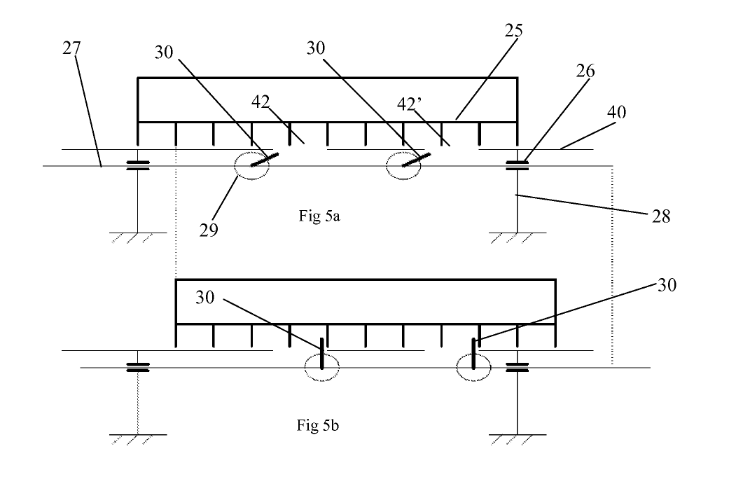

The fourth embodiment is shown in FIGS. 5a and 5b. The difference of the fourth embodiment to the first to the third embodiments is that a finger 30 is moved up and down in a rotating manner. In this embodiment, the transportation mechanism for laterally and intermittently transporting a test tube rack includes a test tube rack 25, a linear guide track 26, a movable supporter 27, a fixed supporter 28, one or more fingers 30 and a gas cylinder 29. The finger 30 is pivotally connected with the movable supporter 27, and is driven to rotate by the gas cylinder 29.

As shown in FIG. 5a, at the initial position, the fingers 30 are at a lower position. At this position, the fingers 30 are below the test tube rack holding plate 40 and the top of the fingers is spaced apart from the holding plate. As shown in FIG. 5b, when the test tube rack 25 needs to be moved laterally to feed a test tube to an analyzer, the gas cylinder 29 drives the fingers 30 to rotate. When fingers 30 are rotated to the vertical position, they extend upward through the openings 42 and 42′ and into grooves of the test tube rack 25. When the movable supporter 27 is moved to the right, the test tube rack 25 is driven to move to the right by the fingers. In this embodiment, the rotation of the finger 30 is driven by the gas cylinder 29, and the extent of the rotation is controlled by the driving mechanism such that the fingers 30 have no direct contact with the test tube rack holding plate 40 at any time during the operation.

According to the present disclosure, the transportation mechanism for laterally and intermittently transporting a test tube rack or a medical analyzer having the transportation mechanism includes one or more fingers and a driving mechanism which drives the finger to move. The finger has two states, one is a loading state when the finger drives the test tube rack to move, the other is an unloading state when the finger is separated from the test tube rack. The driving mechanism may be a linear motion executive element for driving the finger to move in a straight line, such as a linear electric motor, an electromagnet, a gas cylinder or a fluid cylinder. The driving mechanism may also be a rotary motion executive element for driving the finger to rotate, such as a revolving cylinder or an electromagnet.

Although the present disclosure has been described with reference to specific embodiments, such embodiments are not intended to limit the invention. Those of skill in the art can make routine modifications without departing from the spirit and scope of the invention.

What is claimed is:

1. A transportation mechanism for laterally and intermittently transporting a test tube rack, comprising a test tube rack, at least one finger, and a driving mechanism that drives the finger to move; wherein the finger has a loading state and an unloading state in movements of the finger; in the loading state, the finger extends upward and into the test tube rack and drives the test tube rack to move laterally; and in the unloading state, the finger retrieves downward and out of the test tube rack.

2. The transportation mechanism for laterally and intermittently transporting a test tube rack according to claim 1, further comprising a movable supporter and a linear guide track, slideably fit with each other; wherein the driving mechanism is disposed on the movable supporter.

3. The transportation mechanism for laterally and intermittently transporting a test tube rack according to claim 1, wherein the driving mechanism is a linear motion executive element adapted to drive the finger to move linearly, or a rotary motion executive element adapted to drive the finger to rotate.

4. The transportation mechanism for laterally and intermittently transporting a test tube rack according to claim 3, wherein the driving mechanism is a linear motion executive element that drives the finger to move upward and downward.

5. The transportation mechanism for laterally and intermittently transporting a test tube rack according to claim 4, wherein the finger comprises a connecting shaft and a toggling shaft affixed to the connecting shaft; the connecting shaft is connected with a movable part of the driving mechanism, and the toggling shaft is oriented vertically.

6. The transportation mechanism for laterally and intermittently transporting a test tube rack according to claim 5, wherein the movable part of the driving mechanism drives the connecting shaft to move up and down vertically.

7. The transportation mechanism for laterally and intermittently transporting a test tube rack according to claim 5, wherein the movable part of the driving mechanism drives the connecting shaft to move up and down slantingly.

8. The transportation mechanism for laterally and intermittently transporting a test tube rack according to claim 3, wherein the driving mechanism is a rotary motion executive element, and the finger is pivotally connected with the movable supporter.

9. The transportation mechanism for laterally and intermittently transporting a test tube rack according to claim 3, wherein the linear motion executive element is a gas cylinder, a linear electric motor, or an electromagnet.

10. The transportation mechanism for laterally and intermittently transporting a test tube rack according to claim 3, wherein the rotary motion executive element is a revolving cylinder, or an electromagnet.

11. The transportation mechanism for laterally and intermittently transporting a test tube rack according to claim 1, wherein in the unloading state, the finger is reset laterally after the finger is separated from the test tube rack.

12. A medical analyzer comprising the transportation mechanism for laterally and intermittently transporting a test tube rack according to claim 1.
